(19) United States
(12) Patent Application Publication
(10) Pub. No.: US 2002/0088151 A1
(43) Pub. Date: Jul. 11, 2002

(54) Desktop information carrier

(76) Inventor: Birgitte Devos, Berchem (BE)

Correspondence Address: BACON & THOMAS, 4th Floor, 625 Slaters Lane, Alexandria, VA, 22314, US

(21) Appl. No.: 09/754,362

(22) Filed: Jan. 5, 2001

(51) Int. Cl. G09D 3/04

(52) U.S. Cl. 40/119; 40/390

(57) ABSTRACT

The invention relates to a desktop information carrier which comprises a support (1) of foldable material with a bottom part (3) and two walls adjoining thereto and converging towards the top, namely, a front wall (4) and a rear wall (5), and comprises a number of pages (2). One of the walls (4) has a lip (4A) at its upper extremity, and the pages (2) are exclusively attached to the upper extremity of the other wall (5), and in such a manner that, in between two locations, over a distance larger than the largest width of the lip (4A), they are loose from this wall (5) In usage condition, the aforementioned lip (4A) protrudes between said wall (5) and at least one page (2) which then is situated on the wall (4) with the lip (4A)

### BACKGROUND OF THE INVENTION

1. Field of the Invention

This invention relates to a desktop information carrier which comprises a support of foldable material, mostly of cardboard, having a bottom part and two walls adjoining thereto, namely, a front wall and a rear wall, and which comprises a number of pages attached to at least one of the walls, whereby, in usage condition, the front wall and the rear wall are converging from the bottom part on.

2. Discussion of the Related Art

Such desktop information carriers are, for example, desk calendars, thus, calendars which, contrary to the calendars suspended on a wall, are placed or a table, a desk or similar.

Known desk calendars consist of a folded rectangular piece of cardboard, the free extremities of which are fixed to each other over their entire length by means of spiral wire or wire bent to rings which is provided through openings in the extremities. By means of these rings or this wire, the calendar pages, too, are attached.

As a result of the fact that, after folding, the extremities of the piece of cardboard and the pages have to be attached to each other simultaneously, the manufacturing of these known desk calendars is rather complicated.

The extremities of the piece of cardboard are fixedly attached to each other, and afterwards it is no longer possible for the user to unfold the calendar without damaging it.

Furthermore, the extremities of the piece of cardboard which are fixed to each other, have to be straight, such that a special design of the desk calendars practically is excluded. In the known desk calendars, the walls, which the calendar pages are situated, are rectangular.

### SUMMARY OF THE INVENTION

The present invention has an object a desktop information carrier which does not show the aforementioned disadvantages and is of a simple construction, offers a high design variability and can be unfolded again.

According to the invention, this aim is achieved in that one of the walls, at its upper extremity, shows at least one lip and in that the pages are fixed exclusively to the upper extremity of the other wall, and in such a manner that they are attached to this upper extremity only locally and that, in between two locations, over a distance larger than the largest width of the lip, they are loose from this wall, whereby, in usage condition, the aforementioned lip, there where the pages are loose from the last-mentioned wall, protrudes between this wall and at least one page which then is situated on the wall with the lip.

Thus, the two walls are not fixed to each other, as a result of which manufacturing is easy and, by pulling the lip from one wall away from in between the pages and the other wail, the desktop information carrier at any time can be unfolded to a flat unit which takes little space for storing or transport.

The lip can be given different shapes. As the lip, in mounted condition of the desktop information carrier, protrudes at the top, this shape, of course, will catch the eye.

The pages can be attached to the one wall by means of bent wire.

### BRIEF DESCRIPTION OF THE DRAWINGS

With the intention of better showing the characteristics of the invention, hereafter, as an example without any limitative character, a preferred form of embodiment of a desktop information carrier according to the invention described, with reference to the accompanying drawings wherein:

FIG. 1 represents a view in perspective of a desktop information carrier, more particular a desk calendar according to the invention, in usage condition;

FIG. 2 represents a lateral view of the table calendar from FIG. 1;

FIG. 3 represents a cross-section according to line III-III in FIG. 1, drawn at a larger scale;

FIG. 4 represents a view of the desk calendar from the preceding figures, however, in unfolded condition.

### DESCRIPTION OF THE PREFERRED EMBODIMENT

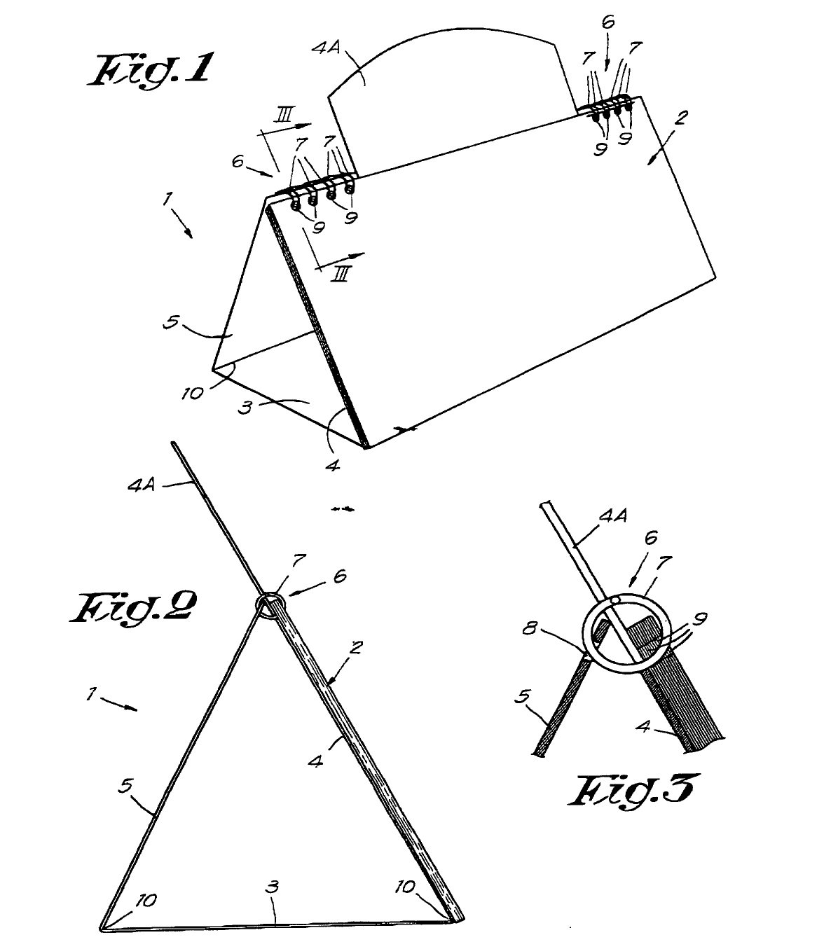

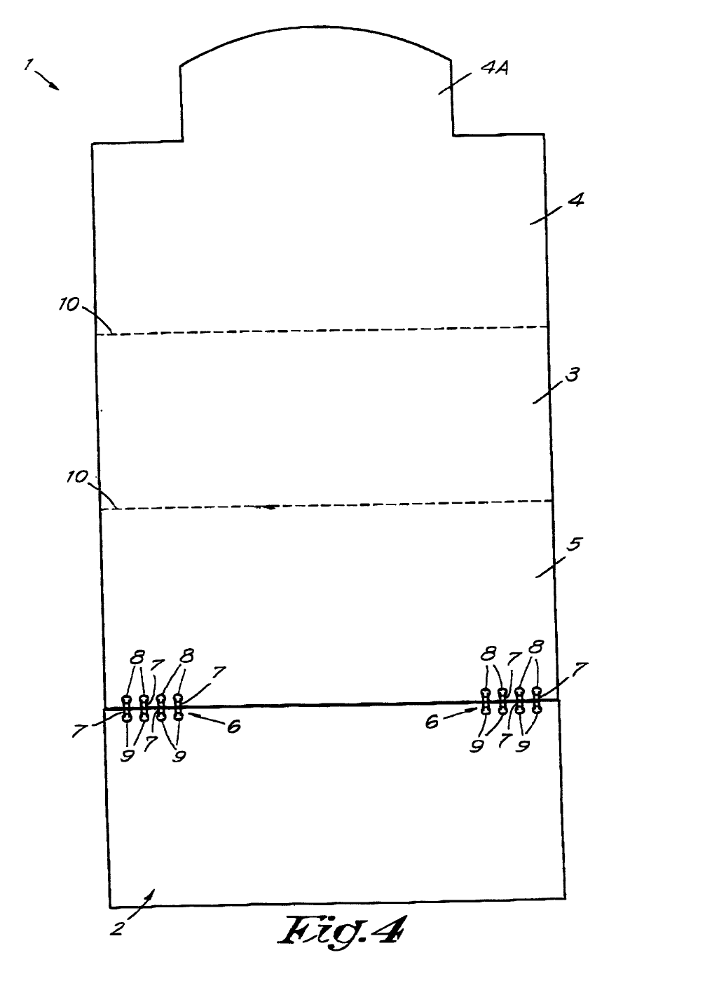

The desk calendar represented in FIGS. 1 and 2 consists of a support 1, formed by a piece of cardboard, and of a number of calendar pages 2, for example, one for every month, an extra front page and possibly a rear page.

This calendar is in usage condition, which means that the piece of cardboard of the support 1 is folded such that it shows a rectangular bottom part 3 and two walls adjoining thereto and standing inclined thereupon namely, a front wall 4 and a rear wall 5 converging towards the top, whereby the front wall 4, at its free extremity, has an upward-protruding lip 4A in the center.

The calendar pages 2 are fixed co the other extremity of the piece of cardboard and, therefore, at the free extremity or upper extremity of the rear wall 5. It is important that the calendar pages 2 are not fixed over the entire length of the upper extremity of the rear wall 6, but exclusively over a small distance starting from the two extremities of the upper edge, this is from the lateral edges of the rear wall 5. In between, and therefore over a large part which is symmetrically in respect to the middle, the calendar pages 2 are loose from the rear wall 5.

The distance over which the calendar pages 2 are loose from the rear wall 5, is larger or equal to the largest width of the lip 4A, measured parallel to the bottom part 3, and this lip 4A, in fact, protrudes upward between said rear wall 5 and at least a number of the calendar paces 2.

Thus, the last-mentioned calendar pages 2 are situated on the front side of the front wall. The portions of the upper edge of the front wall 4 which are situated next to the lip 4A are held by the connections 6 between these calendar pages 2 and the rear wall 5.

In the represented example, two such connections 6 are present, respectively one between the lip 4A and each of the lateral edges of the rear wall 5.

These connections 6 consist of a wire folded in such a manner that it forms springy rings 7 which can be pulled open. Each of these rings 7 protrudes through an opening 8 in the rear wall 5 and opposite openings 9 in each of the calendar pages 2, as, above all, is clearly visible in FIG. 4 in which the desk calendar is represented in unfolded condition.

As is also visible in said FIG. 4, in consideration of folding, the piece of cardboard of which the support 1 is made, is provided with grooves 10, for example, by indentations, perforations or other weakened portions.

Said piece of cardboard is punched out in the desired shape, whereby the lip 4A can take different forms, the grooves 10 are provided and, alongside the edge which is opposed to the edge provided with the lip 4A, the openings B are provided.

Before, in between or after said processing steps, the piece of cardboard is printed.

The calendar pages 2 are cut to size and printed and provided with openings 9 Package per package, by means of connections 6, they are connected to the afore-mentioned piece of cardboard, which takes place before the piece of cardboard is folded and which, therefore, is rather simple.

Subsequently, the desk calendar can be shipped or commercialized in not yet folded condition. The user only has to fold the piece of cardboard according to the grooves 10 and put the lip 4A between the rear wall 5 and the package of calendar pages 2, while letting this package drop around the connections 6 onto the front side the front wall 4.

Possibly, the piece of cardboard can already be folded according to one of the grooves 10 in order to form a more compact unit.

Indeed, it is possible to ship or to commercialize the desk calendar in folded condition. To this aim, the bottom part 3 temporarily has to be folded, such that an additional groove has to be provided in the center of this bottom part 3 and in the longitudinal direction thereof. In usage condition, the bottom part 3 can be flat or still a little by folded.

If a calendar page 2 is no longer necessary, it can be torn off from the connections 6, whereby the openings in this calendar page 2 can form the tear-off line. Possibly, a separate tear-off line can be present.

Instead of tearing off the calendar page 2, it can also be turned around connections 6 towards the rear against the rear wall 5, whereby the lip 4A has to be drawn downward temporarily.

The calendar pages 2 do not necessarily have to connected to the rear wall 5 in the above-described manner. For example, the calendar pages 2 may be glued to the rear wall 5, more particularly to that side thereof which, after the calendar has been formed, is directed towards the front

The afore-mentioned lip 4A can be given different shapes which, for example, are adapted to the print on the support 1 and/or the calendar pages. As this lip 4A protrudes at the top, this shape is very eye-catching such that this lip 4A is particularly suitable for carrying advertisements.

The front wall 4 is not fixedly attached to the rear wall 5, such that, by pulling the lip 4A off, the front wall 4 and the rear wall 5 can be unfastened from each other again.

In fact, the calendar pages 2 hold the front wall 4 against the rear wall 5. In order to avoid that, at the end of the year, when most of the calendar pages 2 are no longer situated on the front wall 4, the support 1 becomes less stable, a stable extra calendar page 2, for example, made of cardboard, can be fixed on the support 1 as a lowermost calendar page 2.

The information printed on the pages does not necessarily always have to be related to the date. Some, or, in certain forms of embodiments, even all pages can carry other information, such as, for example, advertisements, tables of charges, timetables or similar. The desktop information carrier therefore does not necessarily have to be a desk calendar, and the pages not necessarily calendar cages.

The invention is in no way limited to the form of embodiment described heretofore, on the contrary may such desktop information carrier be realized in different variants without leaving the scope of the invention.

I claim:

1. A desktop information carrier which comprises a support of foldable material, having a bottom part, two walls adjoining thereto, namely, a front wall and a rear wall (5), and which comprises a number of pages fixed to at least one of the walls, whereby, in usage condition, the front wall and the rear wall are converging from the bottom part on, whereby one of the walls at its upper extremity has least one lip and the pages are exclusively fixed to the upper extremity of the other wall, in such a manner that they are attached to this upper extremity only locally and that, in between two locations, over a distance larger than the largest width of the lip, they are loose from this wall, and whereby, in usage condition, the aforementioned lip there where the pages are loose from the last-mentioned wall, protrudes between this wall and at least one page which then is situated on the wall with the lip.

2. The desktop information carrier of claim 1, in which the support is made of cardboard.

3. The desktop information carrier of claim 1, in which the pages are fixed to the wall by bent wire which is provided through openings in the pages and openings in said wall.

4. The desktop information carrier of claim 3, in which the pages are fixed on opposite sides, almost starting from the lateral edges, over a distance, at the one wall

5. The desktop information carrier of claim 1, in which the wall to which the pages are attached, is the rear wall and the wall with the lip is the front wall.

6. The desktop information carrier of claim 1, in which the support is provided with grooves between the bottom part, the front wall and the rear wall.

7. The desktop information carrier of claim 6, in which also the bottom part is provided with a groove in the middle.

8. The desktop information carrier according to claim 1, characterized in that it is a desk calendar and at least a number of the pages are calendar pages.

9. The desktop information carrier of claim 1, in which the wall with the lip comprises one single lip in the middle of its upper edge.
